(19) United States
(12) Patent Application Publication
(10) Pub. No.: US 2020/0013405 A1
(43) Pub. Date: Jan. 9, 2020

(54) A WIRELESS EVENT NOTIFICATION SYSTEM WITH VOICE-BASED INTERACTION

(71) Applicant: Carrier Corporation, PALM BEACH GARDENS, FL (US)

(72) Inventors: Pedro Fernandez Orellana, Cork (IE); Ankit Tiwari, South Windsor, CT (US); Daniele Campana, Cork (IE); Hector Moner Poy, Cork (IE)

(21) Appl. No.: 16/493,626

(22) PCT Filed: Mar. 15, 2018
(86) PCT No.: PCT/US2018/022570

§ 371 Date: Sep. 12, 2019

Related U.S. Application Data
(60) Provisional application No. 62/471,438, filed on Mar. 15, 2017.

(51) Int. Cl. G10L 15/22; G06F 21/32; G10L 15/30; G10L 15/26; G10L 17/22

(52) U.S. Cl. CPC G10L 15/22; G06F 21/32; G10L 2015/223; G10L 15/26; G10L 17/22; G10L 15/30

(57) ABSTRACT

A wireless event notification system includes a microphone, a controller, a voice authentication engine, a speech recognition engine, and a wireless device. The microphone is configured to transmit an audible command initiated by a user. The controller is located in a cloud and is configured to receive the audible command. The voice authentication engine is configured to receive the audible command for authenticating the user, and send an authentication signal to the controller. The speech recognition engine is configured to receive the audible command for recognition of the audible command, and send a command text indicative of the audible command to the controller. The wireless device is configured to receive the command text if the controller has received both the authentication signal from the voice authentication engine and the command text from the speech recognition engine.

### BACKGROUND

The present disclosure relates to a wireless event notification system and, more particularly, to a wireless event notification system with voice-based interaction capability.

Internet of Things (IoT) is enabling new and innovative solutions for wireless event notification systems such as security systems. One feature of the security system may be a panel-less system where the logic typically found in a local, hardwired, controller, may now be hosted in a cloud. In such systems, a user smartphone may be the primary interface with the security system. In this way, the system becomes ubiquitous, and may be accessible, generally, everywhere, and not only through an onsite physical interaction. Unfortunately, this newer approach is not always user friendly and other drawbacks may exist relative to security and private communications.

### SUMMARY

A wireless event notification system according to one, non-limiting, embodiment of the present disclosure includes a microphone configured to transmit a voice command initiated by a user; a first controller configured to receive an audible command associated with the voice command; a voice authentication engine configured to receive the audible command from the first controller for authenticating the user, and send an authentication signal to the first controller; a speech recognition engine configured to receive the audible command from the first controller for the recognition of the command, and send a command text indicative of the audible command to the first controller; and a second controller located in a cloud and configured to receive from the first controller an authentication signal and a text command associated with the voice command; and a wireless device configured to receive the command text from the second controller if the second controller has received both the authentication signal and the command text from the first controller.

Additionally to the foregoing embodiment, the first controller is located in the cloud.

In the alternative or additionally thereto, in the foregoing embodiment, the microphone is part of a mobile application.

In the alternative or additionally thereto, in the foregoing embodiment, the first controller is located in the mobile application.

In the alternative or additionally thereto, in the foregoing embodiment, the mobile application is a smart phone.

In the alternative or additionally thereto, in the foregoing embodiment, the wireless event notification system includes a gateway configured to receive the command text from the second controller and send to the wireless device.

In the alternative or additionally thereto, in the foregoing embodiment, the wireless device is an Internet of Things (IoT) device.

In the alternative or additionally thereto, in the foregoing embodiment, the wireless device is a passive infrared camera (PirCAM).

In the alternative or additionally thereto, in the foregoing embodiment, the microphone is part of the wireless device.

In the alternative or additionally thereto, in the foregoing embodiment, the second controller is configured to receive the authentication signal before sending the audible command to the speech recognition engine.

In the alternative or additionally thereto, in the foregoing embodiment, the wireless event notification includes a user interface configured to communicate with the first controller and output a communication to the user to facilitate user identification.

In the alternative or additionally thereto, in the foregoing embodiment, the user interface and the microphone are part of a smart phone.

In the alternative or additionally thereto, in the foregoing embodiment, the speech recognition engine includes a storage medium having at least one preprogrammed audible command for comparison to the audible command.

A method of operating a wireless event notification system according to another, non-limiting, embodiment includes delivering a voice command by a user into a microphone; sending an audible command associated with the voice command to a controller in a cloud; sending the audible command by the controller to a voice identification engine; authenticating a voice of the user by the voice identification engine; confirming authentication with the controller; sending the audible command by the controller to a speech recognition engine; identifying the audible command by the speech recognition engine; sending a command text associated with the audible command from the speech recognition engine to the controller; and sending the command text from the controller and to a wireless device.

Additionally to the foregoing embodiment, the voice identification engine and the speech recognition engine are part of the cloud.

In the alternative or additionally thereto, in the foregoing embodiment, the method includes delivering a confirmation communication from a user interface in communication with the controller and to the user.

In the alternative or additionally thereto, in the foregoing embodiment, the microphone and the user interface are part of a smartphone.

In the alternative or additionally thereto, in the foregoing embodiment, the microphone and the user interface are part of the wireless device, and the controller is a virtual control panel.

In the alternative or additionally thereto, in the foregoing embodiment, the command text sent from the controller to the wireless device is performed through a router, and the wireless device is a PSM device.

A wireless event notification system according to another, non-limiting, embodiment includes a mobile application including a microphone configured to transmit a voice command initiated by a user, a controller located in a cloud and configured to receive an audible command associated with the voice command; a voice authentication engine configured to receive the audible command from the mobile application for authenticating the user, and send an authentication signal to the mobile application; a speech recognition engine configured to receive the audible command from the mobile application for the recognition of the command, and send a command text indicative of the audible command to the mobile application; and a wireless device configured to receive the command text from the controller if the controller has received both the authentication signal and the command text from the mobile application.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic of a wireless event notification system as one, non-limiting, exemplary embodiment of the present disclosure; and

FIG. 2 is a flow chart of a method of operating the wireless event notification system.

### DETAILED DESCRIPTION

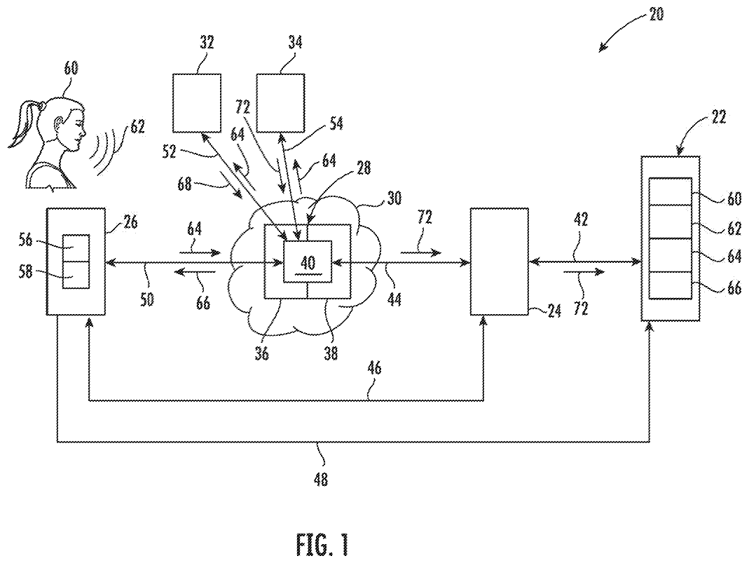

Referring to FIG. 1, an exemplary embodiment of a wireless event notification system 20 is illustrated, and may include a wireless device 22, a gateway 24 (e.g., an Access Point (AP) device indicative of Wi-Fi), a user application 26, a computing server 28 that may be in a cloud 30, a voice identification engine 32, and a speech recognition engine 34. The cloud server 28 may include a processor 36 and a computer writeable and readable storage medium 38 that may support a controller 40 (e.g., virtual control panel) of the wireless event notification system 20. The wireless device 22 and the AP device 24 may be configured to communicate with one-another over a wireless pathway (see arrow 42). The AP device 24 and the virtual control panel 40 may be configured to communicate with one-another over a pathway (see arrow 44) that may be wireless (e.g., 3G access point), may be fiber optics, and/or may be wired. The user application 26 and the wireless device 22 may be configured to communicate with one-another through the AP device 24, and over pathways (see arrows 46 and 42) that may be wireless. Furthermore, the user application 26 may be configured to communicate with the wireless device 22 over a wireless pathway (see arrow 48). The virtual control panel 40 and the user application 26 may be configured to communicate with one-another over a pathway (see arrow 50) that may be wireless. It is understood that the term “gateway” is treated broadly and is indicative of more than just Wi-Fi communications. For example, the gateway may support ZWave.

As illustrated, and in a non-limiting example where the voice identification engine 32 and the speech recognition engine 34 are separate from the cloud server 28, the virtual control panel 40 and the engines 32, 34 may communicate with one-another over respective pathways (see arrows 52, 54) that may be wireless. In one embodiment, the engines 32, 34 may be supported by any cloud computing platform and may be software-based. In one embodiment, the engines 32, 34 may be supported by the cloud server 28, thus communication pathways 52, 54 may generally be eliminated.

In one embodiment, the wireless event notification system 20 may be a security system, and the wireless device 22 may be a passive infra-red camera (PirCAM) device configured to communicate with the cloud server 28 through the AP device 24. In one embodiment, the wireless device 22 may be configured to operate in a Wi-Fi Power Save Mode (PSM), may be an Internet of Things (IoT) device, and/or may be a smart device. Non-limiting examples of the wireless device 22, may include smart home sensors, intrusion sensors configured to detect the opening of windows or doors, thermal sensors configured to measure the temperature of ambient air, gas sensors configured to detect the presence of gases, smoke detectors as part of a safety system, and many other types of devices that may utilize batteries and may communicate wirelessly. In one embodiment, the AP device 24 may be a router having firmware that supports Wi-Fi PSM. In one embodiment, the user application 26 may be a mobile application, and may further be a smart phone. Other non-limiting examples of a mobile application 26 may include a digital media player and a tablet computer.

In one embodiment, the user application 26 may include a microphone 56 and a user interface 58. In operation, a user 60 may speak, initiating a voice command 62 that is received by the microphone 56 of the user application 26 and sent as an audible command (see arrow 64) over pathway 50 to the virtual control panel 40. As part of the user identification process, the virtual control panel 40 may be configured to send a communication (see arrow 66) over pathway 50 to the user interface 58. The communication 66 may be audible and/or visual. In one embodiment, the user interface may include a speaker that may be part of the microphone 56 for audibly communicating the communication. In another, non-limiting, embodiment, the user interface 58 may be a visual screen that may be interactive. It is contemplated and understood that the microphone 56 may not be part of the user application 26, and instead may be local to, or part of, the wireless device 22.

The wireless device 22 may include a power management module 60 (i.e., battery and a means of managing battery power), a sensor and/or actuator 62, a computing processor 64 (e.g., microcontroller), and a wireless transceiver 66. If the wireless device 22 is a PSM device, the wireless device 22 may be configured to enter into sleep and awake states at a pre-determined frequency and duration of time.

The voice identification engine 32 is configured to receive the audible command 64 from the virtual control panel 40, authenticate the user 60, and once authenticated, send an authentication signal (see arrow 68) to the virtual control panel 40. Authentication may be facilitated by comparing the voice (i.e., audible command 64) against prerecorded/trained voice patterns generated by allowed users of the system 20. The trained voice patterns may generally be stored by the engine 32. In another embodiment, the audible command 64 may be sent directly from the user application 26 to the voice identification engine 32. One, non-limiting, example of the voice identification engine 32 may be based on Microsoft Cognitive Services.

The speech recognition engine 34 is configured to receive the audible command 64 from the virtual control panel 40, recognize the command, and once recognized, send a command text (see arrow 70) to the virtual control panel 40. Recognition of the audible command 64 may be facilitated by a comparison to allowed commands stored by the engine 34. In other embodiments, the audible command 64 may be sent directly from the user application 26, or directly from the voice identification engine 32. Non-limiting examples of the speech recognition engine 34 may be based on the speech recognition services from Google Cloud Platform or Microsoft Azure.

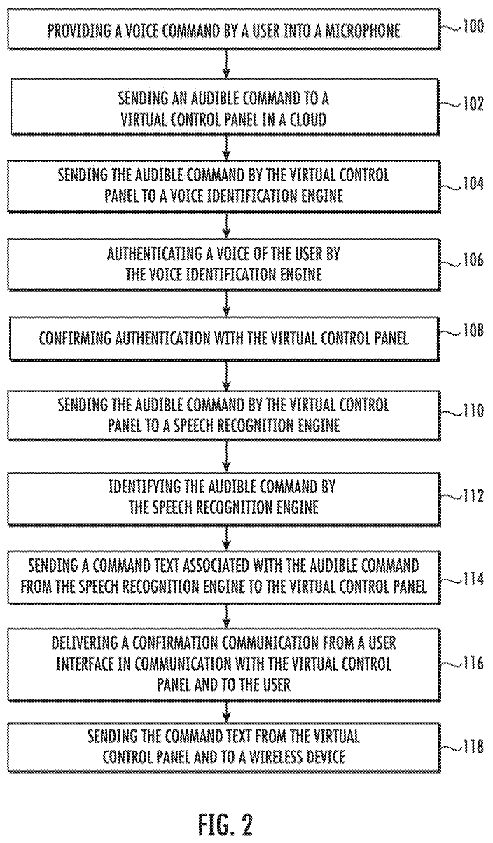

Referring to FIG. 2, a method operating an event notification system 20 is illustrated. At block 100, a voice command 62 is audibly made by a user 60 into a microphone 56. At block 102, an audible command 64, associated with the voice command 62, is sent to a virtual control panel 40 that may be in a cloud 30. At block 104, the audible command 64 is sent by the virtual control panel 40 to a voice identification engine 32. At block 106, the voice identification engine 32 authenticates the audible command 64.

At block 108, the voice identification engine 32 confirms the authentication by sending an authentication signal 68 to the virtual control panel 40 over pathway 52. At block 110, the audible command 64 is sent from the virtual control panel 40 to the speech recognition engine 34 over pathway 54. At block 112, the speech recognition engine 34 identifies the audible command 64. At block 114, the speech recognition engine 34 sends a command text (see arrow 72), indicative of identification of the audible command 64, over pathway 54 to the virtual control panel 40. At block 116, the virtual control panel 40 may send a communication 66 over pathway 50 to the user application 26. The communication 66 may be indicative of failure or success regarding the voice identification and recognition, and/or may request confirmation or other actions from the user 60. At block 118, the command text 72 may be sent from the virtual control panel 40 and to the AP device 24 over pathway 44, then to the wireless device 118 over pathway 42. Once received, the wireless device 22 may act accordingly. In one embodiment, the command text 72 may include an enable or arm system command, and may include a disable or disarm system command.

In other, non-limiting, embodiments, the mobile application may send the voice command to the authentication engine, authenticates the user (i.e., receives a key), sends the voice command to the speech recognition engine, and receives the text message. The mobile application may then send to the controller in the cloud the key and the text message. The controller 40 in the cloud may validate the authentication and may then forward the text message to the wireless device 22.

Advantages and benefits of the present disclosure include a robust and user friendly method to implement user identification for event notification systems through, for example, a smart phone. Other benefits include obviating the need for more traditional pin codes and/or fingerprint approached, reducing cost, and improving maintainability of event notification systems.

The various functions described above may be implemented or supported by a computer program that is formed from computer readable program codes, and that is embodied or stored in a computer readable storage medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other forms.

Terms used herein such as component, module, system, and the like are intended to refer to a computer-related entity, either hardware, a combination of hardware and software, or software execution. By way of example, a component may be, but is not limited to, a process running on a processor, a processor, an object, an executable, a thread of execution, a program, and/or a computer. It is understood that an application running on a server and the server may be a component. One or more components may reside within a process and/or thread of execution and a component may be localized on one computer and/or distributed between two or more computers.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A wireless event notification system comprising:
a microphone configured to transmit a voice command initiated by a user;
a first controller configured to receive an audible command associated with the voice command;
a voice authentication engine configured to receive the audible command from the first controller for authenticating the user, and send an authentication signal to the first controller;
a speech recognition engine configured to receive the audible command from the first controller for the recognition of the command, and send a command text indicative of the audible command to the first controller; and
a second controller located in a cloud and configured to receive from the first controller an authentication signal and a text command associated with the voice command; and
a wireless device configured to receive the command text from the second controller if the second controller has received both the authentication signal and the command text from the first controller.

2. The wireless event notification system set forth in claim 1, wherein the first controller is located in the cloud.

3. The wireless event notification system set forth in claim 1, wherein the microphone is part of a mobile application.

4. The wireless event notification system set forth in claim 3, wherein the first controller is located in the mobile application.

5. The wireless event notification system set forth in claim 4, wherein the mobile application is a smart phone.

6. The wireless event notification system set forth in claim 1, further comprising:
a gateway configured to receive the command text from the second controller and send to the wireless device.

7. The wireless event notification system set forth in claim 6, wherein the wireless device is an Internet of Things (IoT) device.

8. The wireless event notification system set forth in claim 1, wherein the wireless device is a passive infrared camera (PirCAM).

9. The wireless event notification system set forth in claim 1, wherein the microphone is part of the wireless device.

10. The wireless event notification system set forth in claim 1, wherein the second controller is configured to receive the authentication signal before sending the audible command to the speech recognition engine.

11. The wireless event notification system set forth in claim 1 further comprising:
a user interface configured to communicate with the first controller and output a communication to the user to facilitate user identification.

12. The wireless event notification system set forth in claim 11, wherein the user interface and the microphone are part of a smart phone.

13. The wireless event notification system set forth in claim 1, wherein the speech recognition engine includes a storage medium having at least one preprogrammed audible command for comparison to the audible command.

14. A method of operating a wireless event notification system comprising:
delivering a voice command by a user into a microphone;
sending an audible command associated with the voice command to a controller in a cloud;
sending the audible command by the controller to a voice identification engine;
authenticating a voice of the user by the voice identification engine;
confirming authentication with the controller;
sending the audible command by the controller to a speech recognition engine;
identifying the audible command by the speech recognition engine;
sending a command text associated with the audible command from the speech recognition engine to the controller; and
sending the command text from the controller and to a wireless device.

15. The method set forth in claim 14, wherein the voice identification engine and the speech recognition engine are part of the cloud.

16. The method set forth in claim 14, further comprising:
delivering a confirmation communication from a user interface in communication with the controller and to the user.

17. The method set forth in claim 16, wherein the microphone and the user interface are part of a smartphone.

18. The method set forth in claim 16, wherein the microphone and the user interface are part of the wireless device, and the controller is a virtual control panel.

19. The method set forth in claim 16, wherein the command text sent from the controller to the wireless device is performed through a router, and the wireless device is a PSM device.

20. A wireless event notification system comprising:
a mobile application including a microphone configured to transmit a voice command initiated by a user;
a controller located in a cloud and configured to receive an audible command associated with the voice command;
a voice authentication engine configured to receive the audible command from the mobile application for authenticating the user, and send an authentication signal to the mobile application;
a speech recognition engine configured to receive the audible command from the mobile application for the recognition of the command, and send a command text indicative of the audible command to the mobile application; and
a wireless device configured to receive the command text from the controller if the controller has received both the authentication signal and the command text from the mobile application.
